(19) United States
(12) Patent Application Publication
(10) Pub. No.: US 2023/0083781 A1
(43) Pub. Date: Mar. 16, 2023

(54) SYSTEM AND METHOD FOR EVALUATING A CRISIS MANAGEMENT PLAN

(71) Applicant: BE-STRATEGIC SOLUTIONS LTD, Herzliya (IL)

(72) Inventors: Dotan SAGI, Tel-Aviv (IL); Carmit RAPAPORT-LYAKAS, Haifa (IL); Alan Barry KIRSCHENBAUM, Sede Yaakov (IL)

(21) Appl. No.: 17/774,428

(22) PCT Filed: Nov. 10, 2020
(86) PCT No.: PCT/IL2020/051164

§ 371 Date: May 4, 2022

Related U.S. Application Data
(60) Provisional application No. 62/933,454, filed on Nov. 10, 2019.

(51) Int. Cl. G06Q 10/0635; G06Q 10/04

(52) U.S. Cl. CPC G06Q 10/0635; G06Q 10/04

(57) ABSTRACT

The invention provides a method for systematically assessing personal and team performance pertaining to important aspects of a plan for dealing with a crisis, such as background of the organization and its members, preparation for the crisis, and execution during the crisis. The invention provides a systematized evaluation mechanism that can measure individual and team performance in an organization and can realistically predict the organization’s probability of successfully dealing with a crisis.

### FIELD OF THE INVENTION

The invention is in the field of systems and methods for business analysis, and in particular relates to a system and method for evaluating efficacy of a crisis management plan and endurance to crisis of an organization.

### BACKGROUND TO THE INVENTION

Systems for evaluating emergency plans are disclosed:

CN107947964A discloses an emergency plan evaluation method and device. The method comprises the steps that for different emergency plans, the following method is performed at least once. The method comprises the steps of performing emergency plan exercises, and acquiring and recording practical values of evaluation indexes in each exercise, wherein the evaluation indexes comprise timeliness evaluation indexes, monitoring items, fault notification personnel and emergency plan identities; calculating expected values of the timeliness evaluation indexes of the emergency plans, and evaluating the reasonability of the timeliness evaluation indexes according to the expected values and preset values of the evaluation indexes; for the monitoring items, the fault notification personnel and the emergency plan identities, judging the reasonability according to the practical values and the corresponding preset values; and forming an evaluation report based on the evaluation results.

US 2006/0009992 A1 discloses a method and/or system for assessing a community’s preparedness, deterrence, and response capability for handling crisis situations. Numerical values representing answers to a series of questions pertaining to a crisis situation preparation domain and a crisis implementation domain are provided. A combined score of the domains is determined based on the numerical values. The combined score is ranked on a scale ranging between poor capability and very good capability for handling crisis situations.

### SUMMARY

Previous methods and systems for analyzing crisis-plan adherence focus on exercises designed to examine the operational aspects of an organization. However, they do not systematically survey human factors. They elucidate what performance is, but fail to provide insight on why or how people perform as they do. Hence the need for a systematized evaluation mechanism that can measure individual and team performance in an organization and can realistically predict the organization’s probability of successfully dealing with a crisis.

The present invention provides a method for systematically assessing personal and team performance pertaining to important aspects of a plan for dealing with a crisis, such as background of the organization and its members, preparation for the crisis, and execution during the crisis.

It is therefore within the scope of the invention to provide a method for evaluating a crisis management plan, the method comprising steps of
a. obtaining planned responses of an organization to a crisis;
b. constructing a planned-response process flow;
c. obtaining member data about one or more members of the organization, the member data comprising expected responses of each the member to the crisis scenario, the expected responses comprising interactions with other the members;
d. computing predicted responses, the predicted member responses computed as a first function of the expected interactions of the member with the other members and expected interactions of the other members with the member, the first function employing uni- and/or multi-variate analysis algorithms;
e. comparing the expected responses with the predicted responses; the comparison comprising one or more types of gaps in one or more phases of the planned responses and the predicted responses;
f. forecasting the probability that the predicted response will cause the organization to succeed in resolving the crisis scenario, the probability computed as a second function of one of the number of gaps;
g. obtaining observed responses during a simulation of the crisis scenario;
h. comparing predicted and observed member responses, the comparison comprising one or more types of gaps in one or more phases of the predicted responses and the observed responses;
i. comparing planned and observed member responses, the comparison comprising one or more types of gaps in one or more phases of the planned responses and the observed responses;
j. comparing predicted and observed organizational responses, the comparison computed as a third function of a number of the gaps in one or more phases of the planned responses and the predicted responses and one of the number of gaps in one or more phases of the predicted responses and the observed responses;
k. analyzing relationships among the players;
l. computing areas needing improvement in the crisis management protocols; and
m. reporting results and the recommended actions.

It is further within the scope of the invention to provide the above method, further comprising a step of identifying one or more most valuable players (MVPs) among the members.

It is further within the scope of the invention to provide any one the above methods, further comprising a step of querying the members during the simulation.

It is further within the scope of the invention to provide any one the above methods, wherein a portion of the collected organizational and/or member data is obtained from databases of the organization, social media, or any combination thereof.

It is further within the scope of the invention to provide any one the above methods, further comprising a step of obtaining organizational data such as a type of industry of the organization; a number and/or geographic distribution of employees; supply chain networks; technological complexity of operations (e.g., extent of robotic online production and/or level of administrative automation such as of automated banking services); and current processes, procedures, and/or organizational structure.

It is further within the scope of the invention to provide any one the above methods, wherein the collected member data further comprises one or more of age; gender; educational level; skill level; training level; number of years in the organization; level of understanding of the organization’s planned crisis scenario response; individual experiences with crises; trust in the organizational procedures; trust in the senior management; and trust in the organization’s rewards.

It is further within the scope of the invention to provide any one the above methods, wherein the expected and actual member responses comprises one or more of performance, behavior, and decision-making processes.

It is further within the scope of the invention to provide any one the above methods, wherein the results comprise one or more in a group comprising swim charts of the expected, predicted, and/or actual crisis-scenario member responses; heat maps; interaction maps; and any combination thereof.

It is further within the scope of the invention to provide any one the above methods, wherein the observed member response data further comprises initiative, diversity, perception, responsiveness, comeback, perceived centrality, burn-out, and any combination thereof.

It is further within the scope of the invention to provide any one the above methods, further comprising a step of scoring one or more member for one or more of degree of centrality to communication, perception of centrality, influence, situational awareness, compliance with pre-determined guidelines, and adaptability; the scores calculated as a function of the observed member response and/or the obtained member data.

It is further within the scope of the invention to provide any one the above methods, further comprising a step of messaging between the members during the simulation, wherein the actual data of a member further comprises data of the messaging of the member.

It is further within the scope of the invention to provide any one the above methods, wherein the second function (for forecasting success) comprises a count of the discrepancies.

It is further within the scope of the invention to provide an apparatus for evaluating a crisis management plan, the apparatus comprising
a. a computer system comprising at least one processor and at least one CRM; and
b. one or more terminals;
c. one or more display devices;
the instructions stored on the CRM are configured for processor to perform the following steps:
d. obtaining planned responses to a crisis;
e. constructing a planned-response process flow;
f. obtaining member data about one or more members of the organization, the member data comprising expected responses of each the member to the crisis scenario, the expected responses comprising interactions with other members;
g. computing predicted responses, the predicted member responses computed as a first function of the expected interactions of the member with the other members and expected interactions of the other members with the member, the first function employing uni- and/or multi-variate analysis algorithms;
h. comparing the expected responses with the predicted responses; the comparison comprising one or more types of gaps in one or more phases of the planned responses and the predicted responses;
i. forecasting the probability that the predicted response will cause the organization to succeed in resolving the crisis scenario, the probability computed as a second function of one of the number of gaps;
j. obtaining observed responses from the terminals during a simulation of the crisis scenario;
k. comparing predicted and observed member responses, the comparison comprising one or more types of gaps in one or more phases of the predicted responses and the observed responses;
l. comparing planned and observed member responses, the comparison comprising one or more types of gaps in one or more phases of the planned responses and the observed responses;
m. comparing predicted and observed organizational responses, the comparison computed as a third function of a number of the gaps in one or more phases of the planned responses and the predicted responses and one of the number of gaps in one or more phases of the predicted responses and the observed responses;
n. analyzing relationships among the players;
o. computing areas needing improvement in the crisis management protocols; and
p. reporting results and the recommended actions on said display devices

### BRIEF DESCRIPTION OF THE DRAWINGS

FIG. 1 shows steps of a method for evaluating an organization’s preparedness for a crisis, according to some embodiments of the invention.

FIG. 2 shows a non-limiting example of a process flow for an expected (planned) crisis-scenario response, produced according to some embodiments of the invention.

FIG. 3 shows a non-limiting example of a process flow for predicted crisis-scenario responses, produced according to some embodiments of the invention.

FIG. 4 shows a non-limiting example of a process flow for observed responses to a simulation of a crisis scenario, produced according to some embodiments of the invention.

FIG. 5 conceptually shows an aspect of some embodiments of the invention.

FIG. 6 shows a non-limiting example of interaction maps of predicted and observed responses, produced according to some embodiments of the invention.

FIG. 7 shows a non-limiting example of heat maps for predicted and observed responses.

FIG. 8 shows a functional block diagram of a system for evaluating an organization’s preparedness for a crisis, according to some embodiments of the invention.

### DETAILED DESCRIPTION

“Crisis management protocols” refers to a formal crisis management plan of an organization.

“Game controller” refers to a person or group of persons administering a crisis management evaluation of an organization.

“Organizational responses” refers to taking of actions that embody an organization’s reaction to a crisis.

“Member responses” refer to individual responses to a crisis scenario by members of an organization. Member responses can include self-reported behaviors.

“MVP (most valuable player),” “central player,” and “key influencer” refer to a player observed to have a high degree of interactions with other players.

“Predicted Influential Player” refer to a player predicted to have a high degree of interactions with other players.

“Planned (or expected) crisis responses” (EX) refers to an organization’s planned responses to a crisis. The planned responses can be from a formal crisis management plan and/or responses as perceived by senior managers of the organization. (Two-letter abbreviations are used in a notational designation further described herein).

“Predicted responses” (PX) refers to responses of members of an organization that are predicted based on information about members of the organization. The member information can include replies to a member questionnaire evaluating the members’ perceived functioning during a crisis.

“Observed responses” (OX) refers to responses to a crisis scenario recorded during a simulation of the crisis scenario played out by members of the organization.

“Stage” refers to one of the above three portions of the crisis-plan evaluation: evaluation of the plan (EX), making a prediction (PX), and observing and analyzing a simulation (OX)

“Player” refers to a member of the organization participating (“playing”) in a simulation of a crisis scenario.

“Phase” (PH) refers to a time-framed period in the crisis management process in which a sequence of EX, PX, or OX response interactions between players take place.

“Player interaction vector” (IX) refers to a number and types of actions, such as interactions between players during a specific phase. This might include an action taken by a single player (such as an interaction with the “system”)

“Interaction types” include direct correspondence, indirect correspondence (for example, if a message is sent as carbon-copied, CCed, and not directly), and any combination thereof.

“Player Involvement” (PI) refers to the number of players planned, expected, or observed to interact in each phase.

“Player response time” (TX) refers to an amount of elapsed time taken by players to carry out player interactions during a specific phase. TX of OX response may differ from the EX or PX time.

“Interaction terminology (lexicon) index” (LX) refers to a number of uses of specific terminology by players during interactions during a specific phase.

“Gap” refers to a performance discrepancy between the stages EX, PX and OX or phases, or a performance difference between performance aspects IX, PI, TX, and LX.

“Endurance” is a measure of the measured ability of the organization and its members to execute a crisis-management scenario as planned or predicted. Endurance increases with a fewer number of gaps. A highest degree of endurance means zero gaps between the planned, predicted and observed performance of players in each phase and between phases, player interaction vectors, and response time.

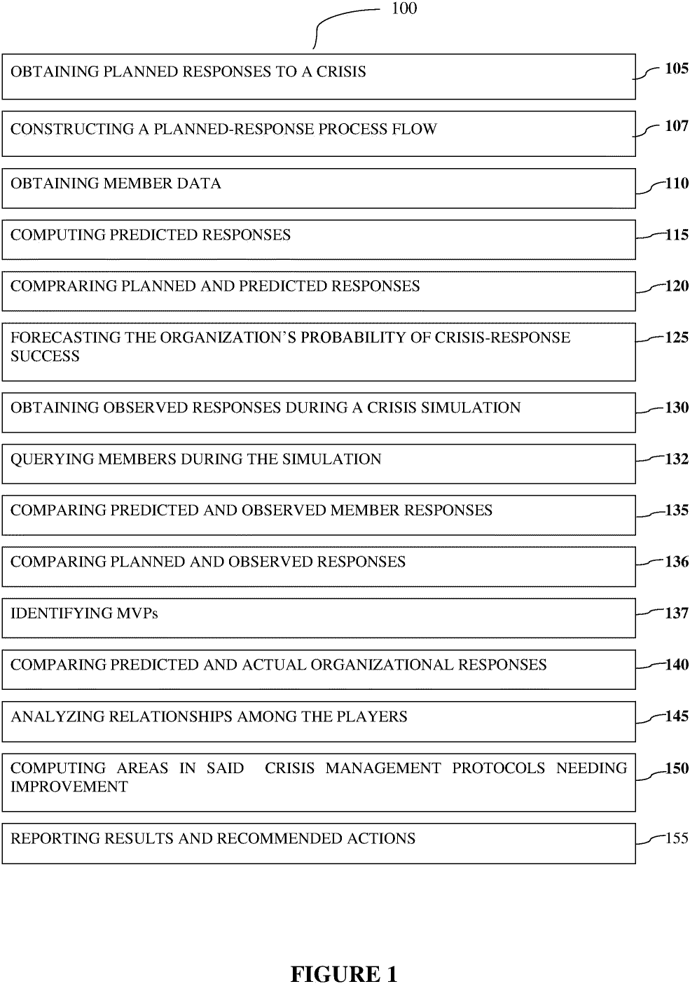

Reference is now made to FIG. 1, showing steps of a method 100 for evaluating an organization’s preparedness for and coping with a crisis, according to some embodiments of the invention. It is understood that method 100 is an embodiment of the invention and that other embodiments may omit or modify some of the steps described below.

Method 100 comprises a step of obtaining data about an organization’s planned responses to a crisis scenario 105. A crisis scenario can be, for example, caused by a fire, a cyber-attack, a natural disaster, a terror attack, adverse publicity, a lawsuit, or any other event harming or potentially harming the organization. The organizational planned response data may comprise a compilation of operating procedures of the organization in the event of a crisis scenario; such procedures may be obtained from a formal crisis management plan of the organization.

In addition to planned response data, data about the organization may also be obtained, such as a type of industry of the organization; a number and/or geographic distribution of employees; supply chain networks; technological complexity of operations (e.g., extent of robotic online production and/or level of administrative automation such as of automated banking services); and current processes, procedures, and/or organizational structure.

In addition to or as an alternative to a formal crisis management plan—if, for example, a formal crisis management plan is not available—the planned organizational response data can comprise organizational crisis responses as perceived by senior managers in the organization. The perceived organizational responses can be obtained by each senior manager’s answers to a management questionnaire querying the procedures the senior manager expects or envisions to be carried out in the event of a crisis. Questions on the management questionnaire can further include: 1) Who declares an emergency? 2) What are your responsibilities when detecting an unusual event? 3) What is the first thing you do? 4) Who is the first person you refer to? 5) What is the organizational sequence of departments and/or individuals who need to be informed so as to deal with the crisis?

If there is disagreement among the senior managers as to the perceived organizational response, an average may be used; the average can be weighted by senior manager according to their administrative power in deciding the organizational response. The organizational data collected from the crisis management plan and/or the management questionnaires may further include desirable outcomes and goals of the organizational responses to the crisis.

Method 100 further comprises a step of constructing a planned-response process flow 107. The planned-response data obtained is collated and analyzed to form the expected-response process flow. The expected-response process flow is organized into phases. In each phase (PH) there is determined a number of planned interactions (IX), among planned involved players (PI) a planned time (TX) of the responses in the phase, and a number of specific terms (LX) used during the phase.

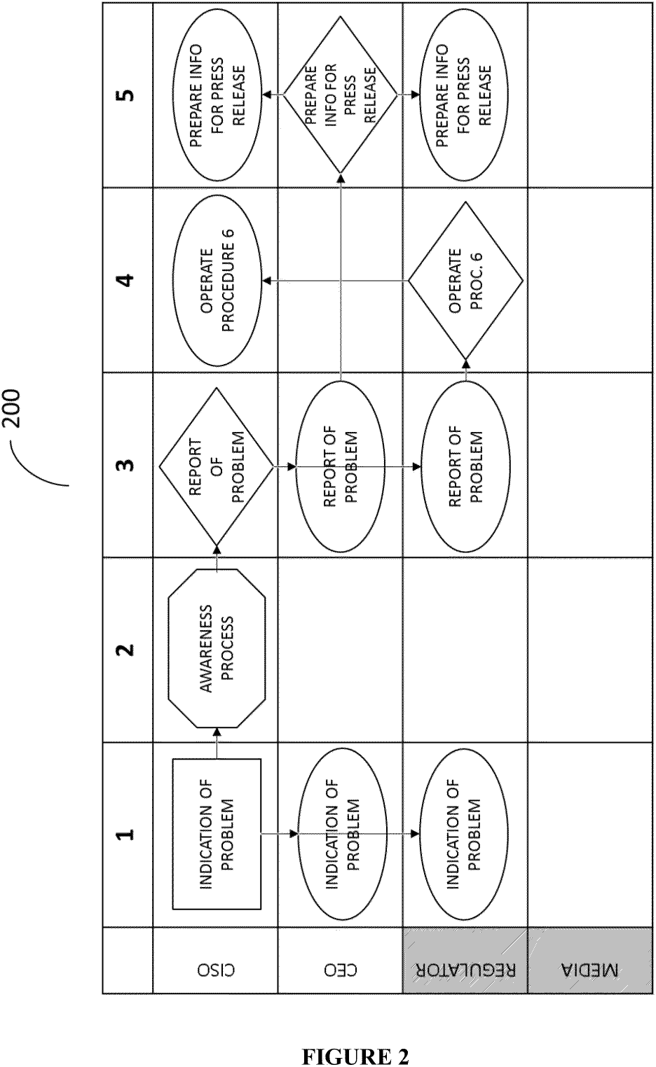

To demonstrate teachings of the invention, a non-limiting example is provided in FIGS. 2-6. FIG. 2 shows a swim chart 200 of an expected-response process flow for a cyber-attack crisis scenario. In this simplified example, there are four members of an organization: a chief information security officer (CISO), chief executive officer (CEO), a regulator (e.g., a banking regulator), and media. When the CISO receives an indication of a problem, he is to notify the CEO and the regulator that there is a problem (phase 1); the CISO is to execute a process called, “awareness process” (phase 2), in which he establishes an understanding of the status of threat leading to taking action. The CISO is to report the problem to the CEO and regulator (phase 3). The regulator is to verify whether procedure 6 needs to be performed and advise the CISO accordingly (phase 4). The CEO is to direct the CISO and regulator to prepare press-release information based on the CEO’s overall judgement regarding the reported threat, for issuing of a press release (phase 5).

Method 100 further comprises a step of obtaining data about one or more members of the organization 110 (which can include senior managers). The member data may comprise each member’s answers to a member questionnaire. The member questionnaire my include questions concerning the member’s own perceived individual responses in the event of a crisis. The member-perceived responses may each be classified as one or more of an action, reaction, and interaction with another member of the organization. The member questionnaire may include questions about personal and team levels of trust and strength of informal social networks. For example: To what extent do you agree with the statements: 1) I consider the senior managers as my friends; 2) If I need professional help, I will first consult the other senior managers.

Obtaining member data 110 may further comprise collecting one or more of a member’s age; gender; educational level; skill level; training level; number of years in the organization; level of understanding of the organization’s planned crisis scenario response; individual experiences with crises; trust in the organizational procedures; trust in the senior management; and trust in the organization’s rewards (e.g., career advancement, monetary reward for performance, health and pension provisions for the employee and family).

All member data obtained 110 (and as further processed) by method 100, may be handled discreetly and kept private; for example, by employing a data collection system whose collected data is accessible to a professional outside organization conducting the crisis management plan evaluation, but not accessible to others including persons in the organization under evaluation.

Method 100 further comprises computing predicted responses during the crisis 115. The predicted response of a member can be computed as a function of the member data, such as member-perceived responses obtained in step 110.

Computing predicted responses 115 may employ collected member data regarding each member’s past behavioral decisions in different situations related to compliance with crisis management protocols. Past behavioral decisions can provide a solid indication of the likelihood of future behaviors. For example, if a member did not pass on information about dealing with a crisis to another member because he/she did not think that person is qualified, it may be predicted that in other situations the member will likewise exhibit distrustful behavioral decisions.

For optimal accuracy in predicting member responses 115, a series of statistical tools and analyses may be employed, such as uni- and/or multi-variate analysis that can be descriptive and/or analytical in nature. These tools can enable predicting member responses as a function of member characteristics — e.g., socio-demographic profiles (age, gender, educational and family status, etc.) as well as past crisis-related behaviors (experience, training, etc.) and organizational statuses (tenure, career, etc.) — garnered from the obtained member data.

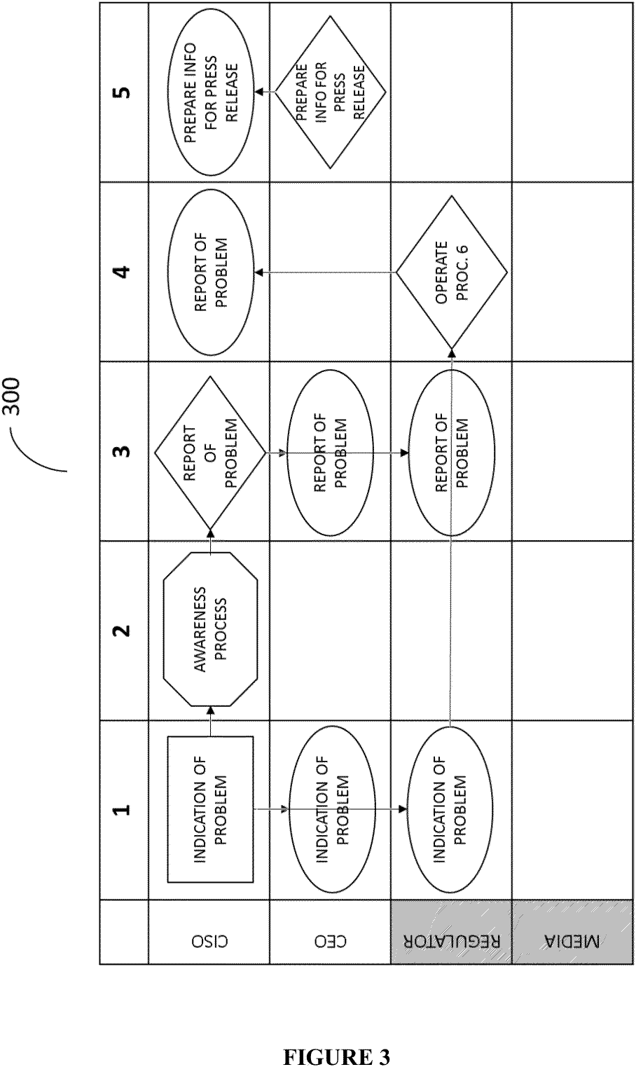

In FIG. 3, an example of a predicted-response process flow 300 is shown. The predicted-response process flow is computed as a function of responses to a member questionnaire administered, in step 110, to the CISO, CEO, and the regulator. The member questionnaire posed the following multiple-choice questions.
1. What is your role / position in the organization?
   Answers: (1) CIO
   (2) CEO
   (3) Spokesperson
   (4) CISO
   (5) Other:______
2. In case you are informed of an unusual activity in the daily IT reports, what is the first thing you do?
   Answers: (1) I notify a colleague.
   (2) I issue an order to shut down the server.
   (3) I start a process of internal inquiry.
   (4) Other. Please specify:______
   (5) I wait for further information.
3. If the answer to question #2 is “I notify a colleague,” who will it be? [Note that answer options to such questions in the actual questionnaire will not include the respondent him/herself.]
   Answers: (1) The CIO
   (2) The CEO
   (3) The regulator
   (4) The spokesperson
   (5) The CISO
4. If the answer to question #2 is 2, 3, 4, or 5, who is the first colleague you will contact?
   (1) The CIO
   (2) The CEO
   (3) The regulator
   (4) The spokesperson
   (5) The CISO
5. Have you experienced working together with the individual selected in question #3 or question #4?
   Answers: (1) Yes
   (2) No
6. If your answer to question #5 is “Yes,” how would you describe this experience?
   Answers: (1) Very good
   (2) Good
   (3) Not so good
   (4) Bad
   (5) Very bad
7. If your answer to question #5 is “Yes,” do you consider the individual selected in question #3 or #4 as your friend?
   Answers: (1) Yes, a close friend
   (2) An acquaintance
   (3) Not a friend at all
8. Do you trust the professional judgement of the individual selected in question #3 or question #4?
   Answers: (1) Yes, completely
   (2) Yes, but not 100% confident in his/her response
   (3) Yes, but would not take a chance
   (4) Not at all / never
9. Does your organization have a crisis-management plan in case of a cyber-attack?
   Answers: (1) Yes
   (2) No
   (3) Maybe, I do not know.
10. If you answered “Yes” to question #9: did you read the plan?
   Answers: (1) Yes
   (2) No
11. If you answered “No” to question #10, did you participate in crisis-management training in case of a cyber-attack?
   Answers: (1) Yes
   (2) No
12. If you answered “Yes” to question #11, when did this training take place?
   Answers: (1) Less than a month ago
   (2) 2 to 6 months ago
   (3) 7 to 12 months ago
   (4) More than a year ago

In practice, questions may be formulated dynamically; that is, subsequent questions and/or answer choices may depend on answers to previous questions.

The collected questionnaire answers might reveal that senior managers show higher levels of trust in one another and positive perceptions of informal social interactions. Such findings could lead to an expectation — based on the Symbolic Interaction Perspective [Mead, G. H., 1934. Mind, Self, and Society, Chicago: University of Chicago Press; and Blumer, H., 1962, “Society as symbolic interactionism,” In A. Rose (Ed.), Human Behavior and Social Processes. London: Routledge and Kegan Paul] — that, when facing a crisis, social relationships among the senior level managers might lead to interactive decision-making responses, such as information sharing and collective awareness. However, such findings can also imply a diffusion of responsibility and longer decision-making processes. In general, these answers might reflect informal social processes within the organization which can later explain gaps between the planned, expected and observed responses.

The predicted-response process flow 300 is computed as a function of questionnaire responses given by the CISO, CEO, and the regulator. For example, the questionnaire yielded the following responses:
The CISO answered as follows:
   Question #1 (4) CISO
   #2 (1) Notify a colleague
   #3 (2) The CEO
   #5 (1) Yes
   #6 (1) Very good
   #7 (1) Yes, a close friend
   #8 (1) Yes, completely
   #9 (1) Yes
   #10 (1) Yes
   #11 was not asked
   #12 was not asked
The CEO answered as follows:
   Question #1 (2) CEO
   #2 (4) Prepare info for press release
   #4 (2) CISO
   #5 (1) Yes
   #6 (1) Very good
   #7 (1) Yes, a close friend
   #8 (1) Yes, completely
   #9 (1) Yes
   #10 (1) Yes
   #11 was not asked
   #12 was not asked
The regulator answered as follows:
   Question #1 (5) Regulator
   #2 (4) Operate procedure 6
   #4 (2) CISO
   #5 (1) No
   #6 (1) Not so good
   #7 (1) Yes, a close friend
   #8 (3) Yes, but would not take a chance
   #9 (1) Yes
   #10 (1) Yes
   #11 was not asked
   #12 was not asked

The predicted-response process flow 300 indicates that when the CISO receives an indication of a problem, he will notify the CEO and the regulator that there is a problem (phase 1), based on the CISO’s answer to questions #2 and #3. The CISO establishes that the threat exists, and takes action, i.e reports the problem to the CEO and the regulator (phase 3), predicted on the basis that the CISO answered “(1) Notify a colleague” in question #2. That colleague is predicted to be the CEO, as the CISO indicated in his answer (2) to question #3. The systems/method will recognize this option (question #2, answers 1 or 2) as an “awareness indication” (phase 2), which indicates that the player has established an understanding of the status of threat in terms of actively taking an action. The regulator verifies whether procedure 6 needs to be performed and advises the CISO accordingly (phase 4). The CEO directs the CISO, but not the regulator to prepare information for a press release (phase 5), based on questions that will be further asked (for the current example we used only the answer #1 to question #2: in case you are informed of an unusual activity in the daily IT reports, what is the first thing you do?”. For other answers to question #2, different subsequent questions pop up such as answer #2: “I issue an order to shut down the server” is followed by a question such as: “Who will you order to shut down the server?”).

The result of this process is the collation and analysis of the information based on player and organizational predicted responses. Analysis of each phase (PH) in the system reveals information on the predicted interactions (IX) between involved players (PI), the predicted time for each response (TX) and use of specific terminology (LX).

Method 100 further comprises comparing the planned responses and the predicted responses 120. A comparison between the EX and PX process flows of the number of interactions (IX) and involved players (PI) is made for each phase. The difference represents a number of gaps in IX, and PI for each phase. The sum of absolute values of interactions and players gaps for all phases is the EX-PX process flow (IX)(PI) gap. The gaps of the EX-PX process flows are also computed for time (TX) and terms (LX). The desired value of all three EX-PX process flow gaps is, of course, zero, indicating there are no gaps.

Computation of a non-zero EX-PX gap when comparing planned and predicted responses 120 can help the organization review its crisis protocols to detect whether there are (1) responsibility gaps: diffusion of responsibility (“who is in charge of what?”); (2) timeline gaps: discrepancies in response time-line (“who reacts when?”); and/or (3) sequence gaps: anomalies in sequence of the response (are there any “black holes” — issues that no one takes care of; or overlaps — issues that more than one person takes care of. At this point, management of the organization can review its crisis plan. The predicted-response swim chart 300, with deviations from planned responses emphasized, can help bring to the attention of the senior managers (preferably after completion of the simulation of step 130, further described herein) at what junctures in the crisis scenario the predicted responses of the organization deviate from the planned responses.

In FIG. 3, the predicted process flow 300 shows that the CISO is predicted to report the problem to the regulator and the CEO-in accordance with the planned response (see FIG. 2, phase 3). However, while the CEO will direct the CISO, as planned, to prepare information for a press release, he will not direct the regulator to do so as planned. This contrast between the planned and predicted responses provides the organization with an important insight regarding the gaps between the organization’s crisis response plan and predicted reactions as actually perceived by the organization’s members. The contrast can be analyzed and explained by reviewing the CISO’s answers to questions #2, 3, 5, 6, 7, and 8; and the CEO’s answers to questions #4, 5, 6, 7, and 8. The CISO’s answers are interpreted as follows: the CISO’s answer to question #3 is “(2) the CEO,” which means that the CISO’s answers to questions #5, 6, and 7 refer to the CEO. Answer “(1) Yes” to question #5, answer “(1) Very good” to question #6 and answer “(1) A close friend” to question #7 are all positive, which means that the relationship between the player (the CISO) and the colleague (CEO, as answered to question #3) is very friendly and based on positive past experience. Positive results were also received from the CEO - the answer to question #4 is “(3) The CISO,” with positive past experience (question #5, answer 1 and question #6, answer 1) and a friendly relationship (question #7, answer 1). Given the two players’ provided mutual, similar answers, the method in step 120 predicts that these players have positive relations. Had there been no match between the dyadic relationships, the method 100 in step 120 would have recognized the CEO-CISO relationship as “not friendly.” However, past experience and trust could still be mutual, and if gaps would eventually emerge, such negative relationships may be discerned as a possible explanation for the gaps. In practical terms, each respondent answers’ will be compared with his/her colleagues’ . When mutual trust is indicated (for example, players answered to question #8 “Do you trust the professional judgement of the individual selected in question #3 or question #4? Answer #1: “yes, completely” for the same person), the system will indicate “green” sign in phases with “0” (zero”) gaps to show that the positive social relationships are in-line with the perceived and planned responses.

The responses of the CISO and CEO reaffirm that the CISO and the CEO are aware of their responsibilities during a cyber-attack crisis, and their decisions are affected by their relationship as they both consider themselves as friends, with positive past experience and mutual trust. These positive relationships, on both sides, increase the likelihood of future cooperation and collaboration.

In the example, the results of comparing planned and predicted responses may be used to alert the organization’s senior managers to a predicted gap in the response of the CEO, in directing the CISO to prepare information for a press release., The CEO does not direct the regulator to prepare info for the press release, although he should do so according to the planned response.

Method 100 further comprises forecasting the probability that the predicted organizational responses will succeed in resolving the crisis scenario 125. The forecast represents the probability of the organization to achieve its goals. Forecasting 125 is based on the data collected from the organization’s crisis response planning and members’ knowledge and attitudes and a quantitative analysis of the gaps between each phase by itself and the whole sequence of phases for the crisis management process as depicted in both planned 200 and predicted 300 process flows.

In the example, the CEO was supposed to direct the CISO and regulator to prepare information for a press release after receiving the report on the problem from the CISO. However, the method in step 115 predicted that the CEO intends to direct the CISO but not the regulator, and therefore the press release will be issued without the regulator’s input. The method 100 in step 120 detected this gap and in step 125 accordingly lowers the predicted probability of success for dealing with the crisis as a whole.

Method 100 further comprises obtaining data of actual or observed responses during a game-play simulation of the crisis scenario 130. In preferred embodiments, players do not see outputs of method 100 (e.g., expected and predicted responses of members and the organization) prior to the simulation, as this could bias their responses. However, a member who assumes a role as a game controller rather than as an active player may see the expected and/or predicted responses. The simulation is preferably conducted with minimal disruption of members’ natural work environment (e.g., using everyday tools, systems, and manners of interaction and without constraints or influence from administrators of the evaluation).

Obtaining observed responses 130 may further comprise tracking activities of the members during the simulation. Each member activity can be counted and classified as one or more of an action, a reaction, and an interaction with another member. The count and classification may be used to determine one or more MVPs (further described herein, including in step 137).

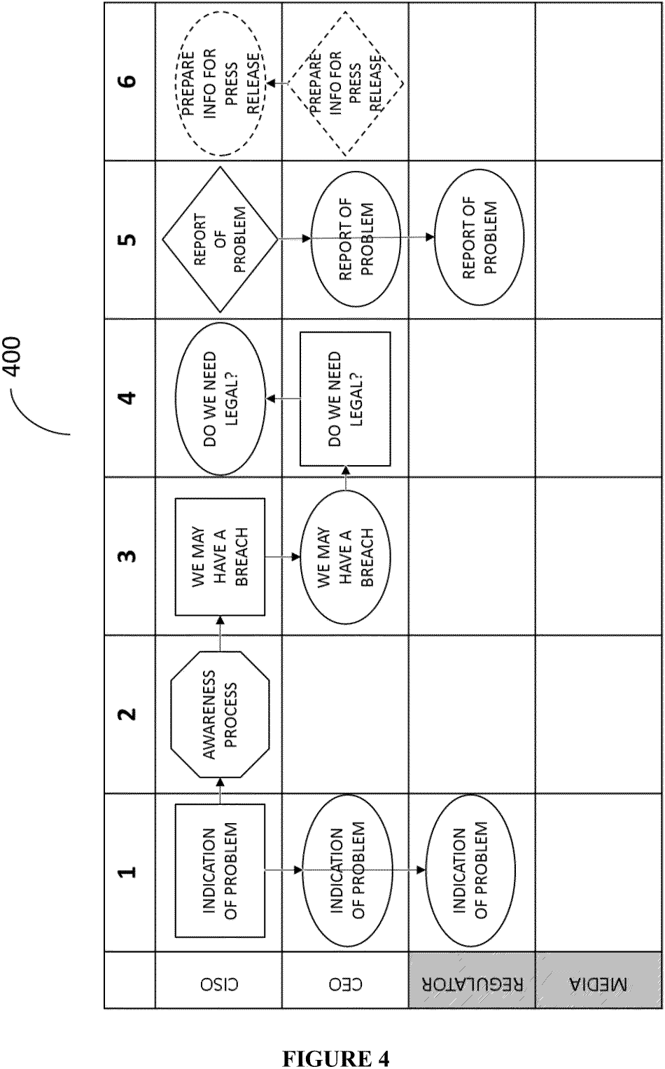

Referring to FIG. 4, a process flow of observed responses 400 shows observed responses between players recorded during the simulation. The CISO received an indication of a problem and announced the problem to the CEO and the regulator (phase 1). The CISO then messaged the CEO that there may be a breach (phase 3). The CEO replied by asking the CISO if legal intervention is required (phase 4). The CISO reported the problem to the CEO and regulator (phase 5). The CEO directed the CISO to prepare information for a press release (phase 6).

Method 100 can further comprise querying members during the simulation 132. Players may be asked the same or similar questions as in the management questionnaire, as a means of contrasting responses and/or outlooks of senior management with those of lower-level members. Furthermore, step 132 can comprise asking players questions at critical decision-making nodes whose answers will likely affect future decisions of how to respond.

The result of this process is the collation and analysis of the information based on player and organizational observed responses. Analysis of each phase (PH) in the system reveals information on the observed interactions (IX), the planned time for each response (TX) and use of specific terminology (LX).

Method 100 further comprises comparing predicted member responses with observed member responses during the simulation 135 and comparing observed member responses with the planned responses 136.

The planned- 200 and predicted- 300 response process flows show that the regulator was planned and predicted to inform the CISO whether to operate procedure 6. The observed-response swim chart 400 shows that the regulator did not do so.

However, the OX has another phase, phase 6, which was not previously predicted in the PX nor planned in by the EX. Given this the interactions for phase 6 would be as follows. Note that since phase 6 does not exist in EX and PX, their phase 6 gaps are all taken as zero.

### Measuring Enduraance Via Gap Scores

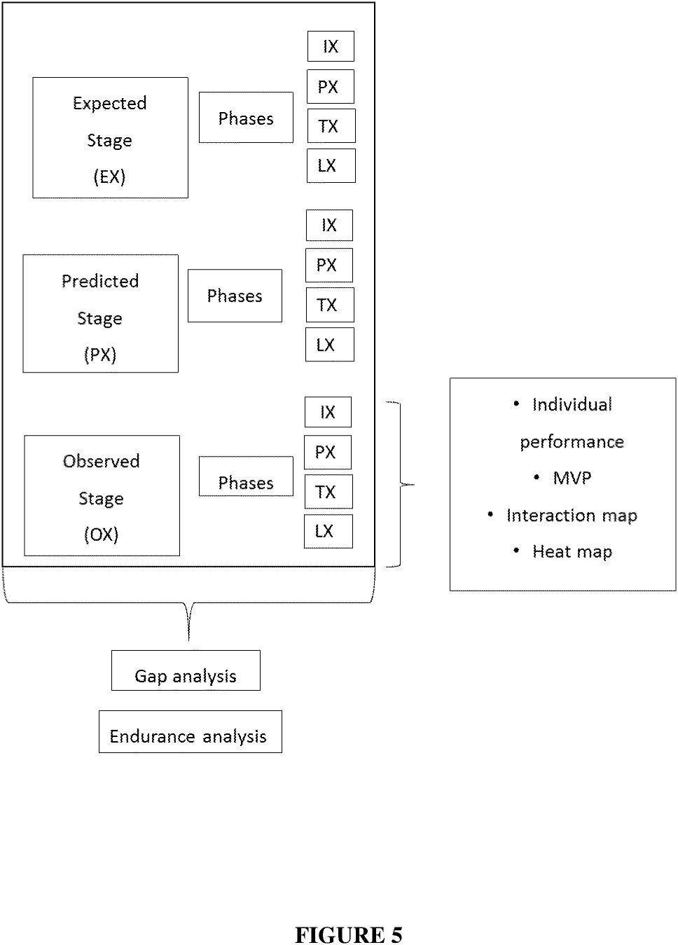

Reference is now made to FIG. 5, showing conceptually an aspect of the invention. In general, method 100 collects data from players and analyze the data in two main streams: the organizational performance and the individual performance. Although these two performances are inter-related, method 100 computes the performance of each player separately and then combines the player performances to compute an entire organizational endurance score. In the phases of each stage, the various aspects of player performance (e.g. IX, PX, TX, and LX) are analyzed and gaps in performance between stages are computed. An analysis of the gaps, as further described herein, provides a value of organizational endurance as well as individual performances, and MVP, an interaction map, and a heat map.

The comparison steps—the steps of comparing planned and predicted responses 120, predicted and observed responses 135, and planned and observed responses 136 are further based on measuring of four elements:
a. Number of interactions among players (IX)
b. Type of players involved (PI)
c. Amount of time (TX), in minutes, needed for a certain interaction
d. Terminology that been used (LX), measured as the number of terms used

The comparison steps entail measuring each of these elements for each phase, in each stage (EX, PX, OX). These measurements are enumerated in Tables 1-4, based on the flow diagrams 200, 300, 400.

TABLE 1

| Phase | Interactions (IX) | | |
|---|---|---|---|
| | EX IX | PX IX | OX IX |
| PH1 | 2 | 2 | 2 |
| PH2 | 1 | 1 | 1 |
| PH3 | 2 | 1 | 1 |
| PH4 | 1 | 1 | 2 |
| PH5 | 1 | 1 | 2 |
| PH6 | 0 | 0 | 1 |

TABLE 2

| Phase | Players involved (PI) | | |
|---|---|---|---|
| | EX PI | PXPI | OX PI |
| PH1 | ABC | ABC | ABC |
| PH2 | A | A | A |
| PH3 | ABC | AB | AB |
| PH4 | AC | AC | AB |
| PH5 | BAC | BA | ABC |
| PH6 | | | BA |

A = CISO
B = CEO
C = Regulator

TABLE 3

| Phase | Time (TX) in minutes | | |
|---|---|---|---|
| | EX TX | PX TX | OX TX |
| PH1 | 1 | 2 | 2 |
| PH2 | 2 | 3 | 3 |
| PH3 | 2 | 2 | 3 |
| PH4 | 2 | 3 | 2 |
| PH5 | 0 | 2 | 1 |
| PH6 | 0 | 0 | 2 |

TABLE 4

| Phase | Terminology (LX) | | |
|---|---|---|---|
| | EX LX | PXLX | OX LX |
| PH1 | 2 | 1 | 3 |
| PH2 | 2 | 2 | 2 |
| PH3 | 1 | 1 | 1 |
| PH4 | 3 | 1 | 2 |
| PH5 | 1 | 2 | 2 |
| PH6 | 0 | 0 | 2 |

The comparison steps further entail calculating the number of gaps in each phase by subtracting the number of gaps (in absolute values) between each pair of stages, EX-PX, EX-OX and EX-OX. by. The result of these calculations for IX, PI, TX and LX are enumerated in Tables 5-8, respectively.

TABLE 5

| Phase | Interactions — IX | | |
|---|---|---|---|
| | EX-PX | EX-OX | PX-OX |
| PH1 | 0 | 0 | 0 |
| PH2 | 0 | 0 | 0 |
| PH3 | 1 | 1 | 0 |
| PH4 | 0 | 1 | 1 |
| PH5 | 0 | 1 | 1 |
| PH6 | 0 | 1 | 1 |
| Total Gaps Difference | 2 | 3 | 3 |

TABLE 6

Players involved — PI

| | EX-PX | EX-OX | PX-OX |
|---|---|---|---|
| PH1 | 0 | 0 | 0 |
| PH2 | 0 | 0 | 0 |
| PH3 | C | C | 0 |
| PH4 | 0 | CB | BC |
| PH5 | C | 0 | C |
| PH6 | 0 | BA | BA |
| Total Gaps Difference | 2 | 5 | 5 |

TABLE 7

Time - TX

| | EX-PX | EX-OX | PX-OX |
|---|---|---|---|
| PH1 | 1 | 1 | 0 |
| PH2 | 1 | 1 | 0 |
| PH3 | 0 | 1 | 1 |
| PH4 | 1 | 0 | 1 |
| PH5 | 2 | 1 | 1 |
| PH6 | 0 | 2 | 2 |
| Total Gaps Difference | 5 | 6 | 5 |

TABLE 8

Terminology - LX

| | EX-PX | EX-OX | PX-OX |
|---|---|---|---|
| PH1 | 1 | 1 | 2 |
| PH2 | 0 | 0 | 0 |
| PH3 | 0 | 0 | 0 |
| PH4 | 2 | 1 | 1 |
| PH5 | 1 | 1 | 0 |
| PH6 | 0 | 2 | 2 |
| Total Gaps Difference | 4 | 5 | 5 |

For each stage EX, PX and OX and each phase PH1-PH6, maximum and minimum potential scores were calculated, which represent the range of possible IX, PI, TX and LX.
For the interactions: given that 4 players appear in the plan, the minimum number of interactions in each phase can be 1 (otherwise it will not be considered as “phase” as nothing has happened at that time), and the maximum number of interactions in each phase is 3.
For the players involved: the minimum relates to the types of players, not the number of players involved in each phase. Therefore, the minimum number of types of players involved is zero, as, for example, if none of the planned players were involved in the observed stage. The maximum number is the number of declared players, in our example, 4 (CEO, CISO, regulator and media).
For the response time: the minimum time for each phase, as the organization representative sets before the simulation can be 1 minute. The maximum, again, as set by the organizations representative is 5 minutes.
For the terminology: the organization representative also sets important term to be used during the crisis management. In our example, the minimum can be 1 term, and the maximum 5 terms.

The comparison steps further entail calculating the gap or the difference between the actual findings (Tables 1-4 above) and the potential minimum (comparing the actual findings to the minimum possible score) and maximum score (comparing the actual findings to the minimum possible score), for each stage, EX, PX and OX. The comparison to the minimum score for each stage appears in the right column, and to the maximum score - appears in the left.

Additionally, the comparison steps further entail calculating-for each stage EX, PX and OX—the sum of the higher gap (be it in comparison with the minimum or the maximum scores - appears in bold) in all phases. For example, for the interactions IX the maximum number is 11+8+9=28.

These results are shown in Tables 9-12.

TABLE 9

IX INTERACTIONS MAX GAPS

| | EXIX | EXIX | PXIX | PXIX | OXIX | OXIX |
|---|---|---|---|---|---|---|
| PH1 | 1 | 1 | 1 | 1 | 1 | 1 |
| PH2 | 0 | 2 | 0 | 2 | 0 | 2 |
| PH3 | 1 | 1 | 0 | 2 | 0 | 2 |
| PH4 | 0 | 2 | 0 | 2 | 1 | 1 |
| PH5 | 0 | 2 | 0 | 2 | 1 | 1 |
| PH6 | 1 | 3 | 1 | 3 | 0 | 2 |
| Sum | 11 | | 8 | | 9 | |

TABLE 10

PI INVOLVED PLAYERS Max Gaps

| | EXPT | EXPT | PXPT | PXPT | OXPT | OXPT |
|---|---|---|---|---|---|---|
| PH1 | 3 | 1 | 3 | 1 | 3 | 1 |
| PH2 | 1 | 3 | 1 | 3 | 1 | 3 |
| PH3 | 3 | 1 | 2 | 2 | 2 | 2 |
| PH4 | 2 | 2 | 2 | 2 | 2 | 2 |
| PH5 | 3 | 1 | 2 | 2 | 3 | 1 |
| PH6 | 0 | 4 | 0 | 4 | 2 | 2 |
| Sum | 18 | | 16 | | 15 | |

TABLE 11

TX TIME Max Gaps

| | EXTX | EXTX | PXTX | PXTX | OXTX | OXTX |
|---|---|---|---|---|---|---|
| PH1 | 0 | 4 | 1 | 3 | 1 | 1 |
| PH2 | 1 | 3 | 2 | 2 | 2 | 2 |
| PH3 | 1 | 3 | 1 | 3 | 2 | 2 |
| PH4 | 1 | 3 | 2 | 2 | 1 | 3 |
| PH5 | 1 | 5 | 1 | 3 | 0 | 4 |
| PH6 | 1 | 5 | 1 | 5 | 1 | 3 |
| Sum | 23 | | 18 | | 15 | |

TABLE 12

LX TERMINOLOGY Max Gaps

| | EXLX | EXLX | PXLX | PXLX | OXLX | OXLX |
|---|---|---|---|---|---|---|
| PH1 | 2 | 3 | 1 | 4 | 3 | 2 |
| PH2 | 2 | 3 | 2 | 3 | 2 | 3 |
| PH3 | 1 | 4 | 1 | 4 | 1 | 4 |
| PH4 | 3 | 2 | 1 | 4 | 2 | 3 |
| PH5 | 1 | 4 | 2 | 3 | 2 | 3 |
| PH6 | 0 | 5 | 0 | 5 | 2 | 3 |
| Sum | 22 | | 23 | | 19 | |

The comparison steps further entail-for each stage EX, PX and OX— calculating “probability of success scores. For example, the “real-time” number of interactions revealed 8 gaps (2+3+3 Table 5). Therefore, the percentage of success is 1-(8/28)= 1-0.29=71% . Table 13 shows the probability of success scores.

TABLE 13

| | Gaps | Real | Success Probability |
|---|---|---|---|
| IX | 28 | 8 | 71% |
| PI | 49 | 12 | 76% |
| TX | 56 | 16 | 71% |
| LX | 64 | 14 | 78% |
| Total | 197 | 50 | 75% |

The comparison steps further entail calculating endurance, the ratio between total gaps and real data in each stage EX, PX and OX. The endurance results are shown in Table 14. The total endurance score in the current example is 74%, which means that the organization’s ability to follow its crisis plans is 74%. Furthermore, the highest score, or minimum gaps, were achieved between the expected and predicted stages. This means that the organization’s plan matches the perceived or predicted response.

TABLE 14

| | Max. Potential Gaps | Real | Endurance |
|---|---|---|---|
| EX-PX | 74 | 12 | 84% |
| EX-OX | 65 | 20 | 69% |
| PX-OX | 58 | 19 | 67% |
| Total | 197 | 51 | 74% |

In some embodiments, method 100 further comprises a step of identifying one or more central players 137, or “MVPs.” The method 100 in step 130 counted each activity performed by each player. Players who initiate actions and interactions (i.e notify or direct other players, correspond with other players etc.) or react to other players actions (replying to notifications according to their content) receive higher MVP scores.

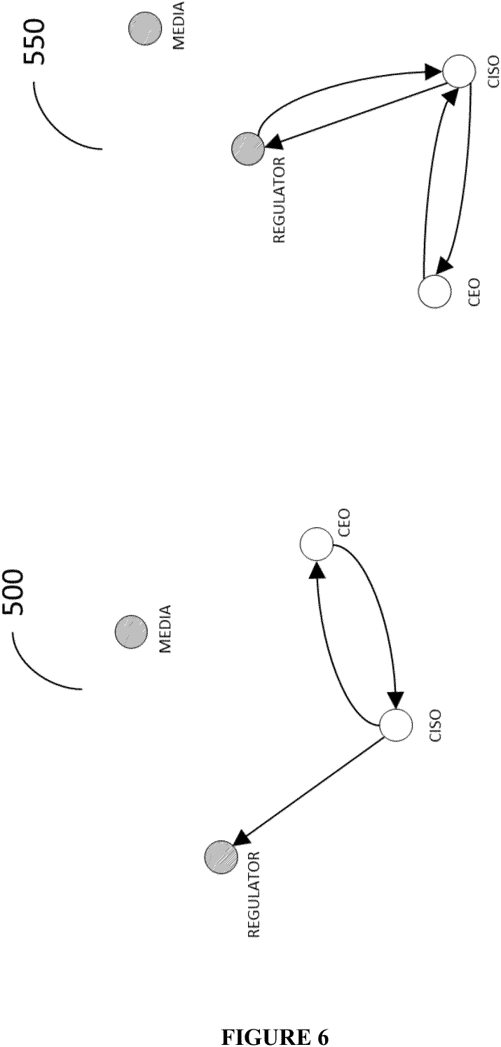

FIG. 6 shows interaction maps of predicted responses 500 and of observed responses 550. In predicted-response interaction map 500, the CISO exhibits the same extent of interactions as other players (i.e., the CEO). In observed-response interaction map 550, the CISO exhibits a greater extent of interaction than other players. In the OX, therefore, the CISO is identified as an MVP.

Players may receive scores for their degree of centrality in the crisis scenario simulation. Scores may be awarded in different categories, such as degree of centrality to communication, perception of centrality, influence, situational awareness, compliance with pre-determined guidelines, maintaining expected performance under pressure, and adaptability to changing conditions. The system further compares observed to predicted MVP’s as to the centrality of different players.

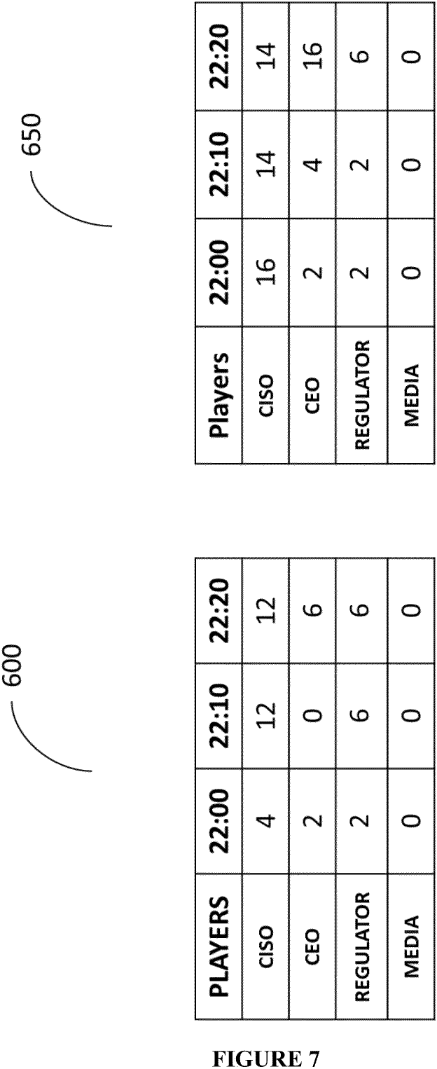

In FIG. 7 is shown a heat map for predicted responses 600 and for observed responses 650. The heat maps scores by player and by time slots, so heat maps show temporal profile of work pressure on each player during the predicted and observed process flows.

Method 100 further comprises comparing predicted and actual organizational responses 140. Actual organizational responses refer to procedural actions which lead to organizational goal attainment. Organizational responses can be constructed from observed member responses and any other data relevant to the actual organizational response collected during the simulation. The gaps analysis might point on gaps within stages, between phases, and between the IX, PX, TX and LX. Further analysis such as the player(s) questionnaire responses 110 and the MVP will provide objective performance measurement, which will help the organization to better understand the causes for the gaps. For example, negative relationships as found in the questionnaires’ answers between players would serve as a possible explanation for gaps in PX between planned and observed stages. The CEO is predicted to be involved in 3 actions along 5 phases: 1 as initiator and 2 as recipient.

In the observed data 400, we see that the CISO is involved in 6 action along 6 phases, and he initiated 4 actions, and receives 2.

The CEO is involved in 5 action along 6 phases: he receives 3 action and initiated 2.

The results will show that, as predicted, the CISO was actually the most influential with more interactions than any other player. If a gap was identified, it is added to a different list of gaps (a gap like this considered as part of the performance measurement, while the calculated gaps described above refers to organizational performance) and will be part of the computation of the final score showing the predicted organization’s endurance to a future crisis.

The predicted process flow 300 shows that the CEO was predicted to direct the CISO to prepare information for a press release (phase 5). The observed-response swim chart 400 shows that the CEO in fact directed the CISO to prepare information for a press release, as predicted but contrary to the planned response in which the CEO was to direct both the CISO and the regulator to prepare information for a press release.

Comparing the planned and predicted organizational responses 140 can further call attention to gaps in the predicted versus actual actions. In cases where members respond in full accordance with the expected or predicted responses, or adapt their actions according to an evolving situation, then the method 100 can estimate chances of success in following the expected responses, i.e exhibit endurance. A desirable result of a member can be: (a) the member took action they should have done according to the plans in a timely manner; and/or (b) the member took an “unexpected” action but eventually the entire expected-response process flow was carried out.

The member characteristics may be combined with the actual decisions made during the simulation, and analyzed so as to aid in helping predict likely future crisis decision-making behaviors among the members. This information can then be aggregated, employing statistical tools to aid in forecasting the effectiveness of overall organizational crisis response.

Method 100 further comprises analyzing relationships among the players 145. These relationships include trust, positive or negative past experience (if any at all) and degree of positive relationship. In a case where one or more gaps appear between the predicted and observed stages, the method will compare the relationship diagnosis with the gaps to provide the organization with insights regarding the reason for these gaps.

Member responses to questionnaires can serve as a diagnostic tool and provide explanations for discrepancies detected between the planned, predicted, and/or observed responses.

In the example, responses by the CEO and CISO, in the questionnaire herein, to questions #2, 3, 5, 6, 7, and 8 reveal that an informal relationship between the CISO and the CEO exists, with positive past experience and trust, and therefore it is likely that, given a situation of uncertainty, the relationship will continue. The CISO’s answers will be computed as the following: the answer to question #3 is (2) the CEO which means that the following answers will refer to this person. The answer 1 to question 5 “yes”, answer 1 to question #6 and answer 1 to question #7 are all positive which means that the relationship between the player (AKA the CISO) and the colleague (CEO, as answered to question 3) are very friendly and are based on positive past experience. These positive results were also received from the CEO - answer to question #4 is 3 (CISO), with positive (question #6, answer 1) past experience (question 5 answer 1) and friendly relationship (question #7, answer 1). Given that the CEO and CISO provided mutual, similar answers, the system recognizes that these players have positive relations. In general, if there is no match between the responses of two players regarding their relationship, the system will recognize the relationship as “not friendly” (although past experience and trust could be mutual), and if gaps would eventually emerge, such relationships will be a possible explanation for the gap.

Reference is now made again to FIG. 4. As explained herein, a “good and positive relationship” is presented and calculated from the number of CEO-CISO interactions. In the observed process flow 400, it appears that the CEO follows the planned response 200 and the predicted-response 300, and directs the CISO to prepare information for a press release. The observed behavior reaffirms the planned and predicted responses, giving a quantitative degree of confidence that the CEO and CISO will follow the crisis management protocol and allows the organization management to be confident, according to the degree of confidence, that comprehension and compliance with procedures exists. The observed process flow 400 also reveals the positive relationship between the CEO and the CISO, which is reflected by interactions between the CEO and CISO in phases 3, 4, and 6.

Method 100 further comprises computing areas in said crisis-management responses needing improvement 150.

Improvements are computed in three areas: (a) procedural improvements — what is the observed “natural” process (i.e., a process that is performed in a normal manner as a response to the external simulated event. i.e. the crisis scenario, in the natural organizational environment; and whether this is the planned and/or predicted result(s), For example, the process of reacting to the external simulated event has occurred in the planned and / or expected time allocated for this goal (to see if an action has occurred but took a very long response time); (b) behavioral improvement — do members know their responsibilities according the crisis management plan, trust the plan, act according to it, and adapt it to uncertain situations? (c) Attitude improvements — the results highlight total organizational attitude towards crisis, risk culture, management-workers relationships. The computing of improvements is made as a function of discrepancies between the planned responses and observed response at specific points along the timeline of the crisis, the analysis of the degree to which the organizations is able to apply its crisis planning, and the reason(s) for the discrepancies.

One of the clearest signs that an organization is able to mitigate or deal with a crisis is that its pre-determined protocols are fully operational and result in little or no loss to the organization’s assets (financial, image, etc.). Where a gap exists (gap in type of players involved, timeline, or sequence), emphasis is placed on one of the above three areas for improvement. For example, observed responses may indicate that specific members in the protocol process flow ignore protocol, are not responsive to receiving orders, or disregard assigned tasks. This type of disruption is identified as a gap in responsibility. The identified gaps equip the organization and its members to formulate and implement behavioral improvements needed to remedy the situation.

Method 100 further comprises reporting the results and the recommended actions 155.

In cases when gaps were found between stages and phases, method 100 will use the relationship diagnosis and its components (as further described herein, including in the discussion describing FIGS. 6-7) in order to show what the gaps mean: lack of knowledge of procedures, lack or functioning during crisis or uncertainty, time lag until performance during crisis, un-involvement of certain player, etc.

Recommendations may be presented visually as bar/pie charts of the results of the questionnaires (not shown), heat-maps of interactions (as shown in FIG. 7), and swim charts (FIGS. 2-4), as further described herein. The system will highlight the discrepancies and gap. The client will choose to refer to each of the presented parameters of interest.

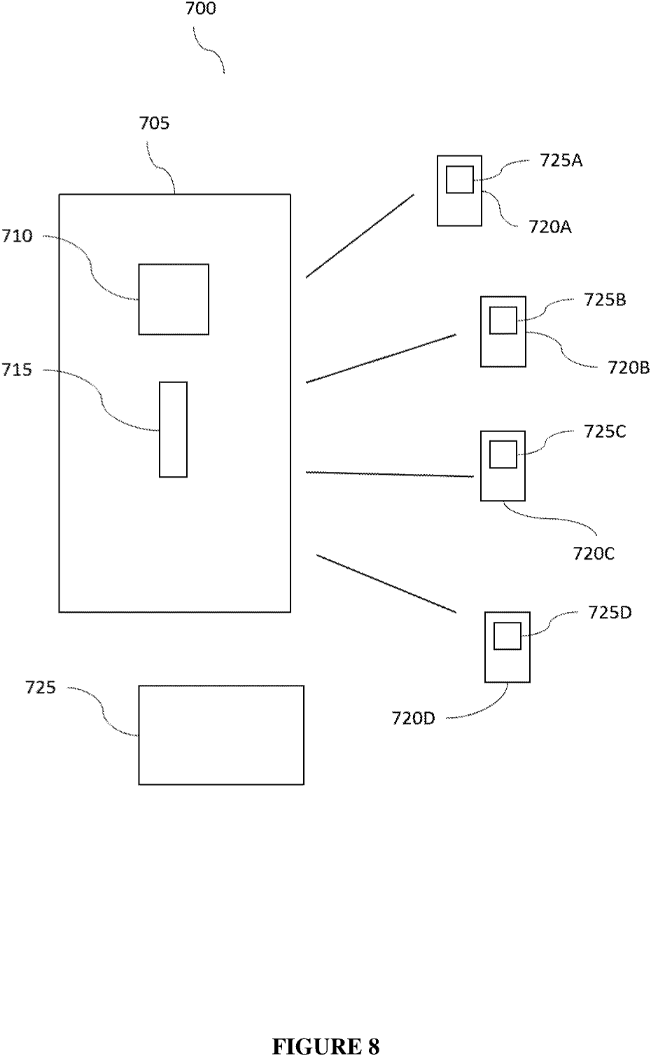

Reference is now made to FIG. 8, showing components of an apparatus 700 for evaluating an organization’s preparedness for a crisis, according to some embodiments of the invention.

Apparatus 700 comprises a computer system 705 comprising a processor 710 and a non-transitory computer-readable medium (CRM) 715 such as an electronic memory or a removable storage medium. Computer system 705 may be a single computer, such as a server, at one location or a plurality of computers networked — for example, locally over a LAN or remotely over a WAN such as the Web, a VPN, or cloud — employing any combination of wired and wireless protocols. Computer system 705 is configured with software providing functions needed for administering an evaluation of an organization’s preparedness for a crisis, such as collecting questionnaire answers and making calculations further described herein.

Apparatus 700 may further comprise one or more terminals 720A-D in communication with computer system 705. Terminals 720 are typically each in the possession of a player. Terminals 720 can be any type of computing device, including a desktop computers, notebook computers, and/or mobile devices such as smartphones or tablet computers. Terminals 720A-D may further be configured for communication between one another. Communication connections of terminals 720A-D with computer system 705 and other terminals 720 can be made in any fashion — for example, locally over a LAN or remotely over a WAN such as the Web, a VPN, or cloud — employing any combination of wired and wireless protocols. Terminals 720 are configured with software designed for functions needed by members of an organization for evaluating an organization’s preparedness for a crisis, such as a means of input for user responses to questionnaires and messaging, further described herein.

Apparatus 700 may further comprise one or more display devices 725. A display device 725 may be a part of or be in connection with computer system 705 and/or one or more terminals 720A-D. Display device 725 is a device suited for display of results computed by computer system 705.

Instructions stored in CRM 715 are configured for processor 710 (optionally in communication with terminals 720A-D) to perform the following steps:
a. obtaining planned responses to a crisis;
b. constructing a planned-response process flow;
c. obtaining member data about one or more members of the organization, the member data comprising expected responses of each the member to the crisis scenario, the expected responses comprising interactions with other the members;
d. computing predicted responses, the predicted member responses computed as a first function of the expected interactions of the member with the other members and expected interactions of the other members with the member, the first function employing uni- and/or multi-variate analysis algorithms;
e. comparing the expected responses with the predicted responses; the comparison comprising one or more types of gaps in one or more phases of the planned responses and the predicted responses;
f. forecasting the probability that the predicted response will cause the organization to succeed in resolving the crisis scenario, the probability computed as a second function of one of the number of gaps;
g. obtaining observed responses from the terminals 720 during a simulation of the crisis scenario;
h. comparing predicted and observed member responses, the comparison comprising one or more types of gaps in one or more phases of the predicted responses and the observed responses;
i. comparing planned and observed member responses, the comparison comprising one or more types of gaps in one or more phases of the planned responses and the observed responses;
j. comparing predicted and observed organizational responses, the comparison computed as a third function of a number of the gaps in one or more phases of the planned responses and the predicted responses and one of the number of gaps in one or more phases of the predicted responses and the observed responses;
k. analyzing relationships among the players;
l. computing areas needing improvement in the crisis management protocols; and
m. reporting results and the recommended actions on the display devices 725.

Obtained data may be read by processor 710 from databases, such as employee records, stored in CRM 715 and/or any of terminals 720, or may be entered into computer system 705 or terminals 720 by users, such as senior managers or members of the organization whose crisis management plan is under evaluation.

The reported results may be displayed on display device(s) 725, such as a monitor or printer of computer system 705 or display screen(s) of terminal device(s) 720.

Instructions in CRM 715 may be configured to cause processor 710 to act in accordance with any embodiment further described herein of method 100.

1-13. (canceled)

14. A method 100 for evaluating a crisis management plan, the method 100 comprising steps of
obtaining planned responses of members of an organization to a crisis, said planned responses comprising planned operating procedures of the organization in the event of a crisis 105; and constructing a planned-response process flow 107;
obtaining data from questionnaires administered to members of the organization on said members social interactions, past experience and predicting member responses flow
simulating a crisis scenario and obtaining data on responses of members during the simulated crisis and constructing observed member responses process flow
recording gaps or differences between said planned responses of the members of the organization and the predicted responses of the members of the organization
planned responses and observed responses
predicted responses and observed responses.

15. The method of claim 14, wherein said steps further comprise
a. computing said predicted member responses as a first function of predicted interactions of said member with said other members and interactions of said other members with said member, said first function employing uni- and/or multi-variate analysis algorithms; and said planned operating procedures are obtained from crisis management protocols of the organization, from said planned procedures, or any combination thereof
b. constructing a predicted-response process flow and comparing the planned-response process flow with the predicted-response process flow 120; said comparison comprising one or more types of gaps in one or more phases of said planned responses and said predicted responses,
c. forecasting the probability that the predicted response will cause said organization to succeed in resolving the crisis scenario 125, said probability computed as a second function of a said number of gaps 130;
d. constructing an observed-response process flow and comparing predicted and observed member responses 135, said comparison comprising one or more types of gaps in one or more phases of said predicted responses and said observed responses,
e. comparing the planned-response process flow with the observed-response process flow 136, said comparison comprising one or more types of gaps in one or more phases of said planned responses and said observed responses,
f. comparing predicted and observed organizational responses 140, said comparison computed as a third function of a number of said gaps in one or more phases of said planned responses and said predicted responses and a said number of gaps in one or more phases of said predicted responses and said observed responses;
g. analyzing relationships among the players 145;
h. computing areas needing improvement in said crisis management protocols 150; and
i. reporting results and the recommended actions 155.

16. The method of claim 14, wherein said expected member responses are obtained from answers to a questionnaire administered to said members; and/or by collecting one or more of a member’s age; gender; educational level; skill level; training level; number of years in the organization; level of understanding of the organization’s planned crisis scenario response; individual experiences with crises; trust in the organizational procedures; trust in the senior management; and trust in the organization’s rewards (e.g., career advancement, monetary reward for performance, health and pension provisions for the employee and family).

17. The method of claim 14, further comprising a step of identifying one or more most valuable players (MVPs) among said members 137.

18. The method of claim 14, further comprising a step of querying said members 132 during said simulation.

19. The method of claim 14, wherein a portion of said collected organizational and/or member data is obtained from databases of the organization, social media, or any combination thereof.

20. The method of claim 14, further comprising a step of obtaining organizational data such as a type of industry of the organization; a number and/or geographic distribution of employees; supply chain networks; technological complexity of operations (e.g., extent of robotic online production and/or level of administrative automation such as of automated banking services); and current processes, procedures, and/or organizational structure.

21. The method of claim 14, wherein said collected member data further comprises one or more of age; gender; educational level; skill level; training level; number of years in the organization; level of understanding of the organization’s planned crisis scenario response; individual experiences with crises; trust in the organizational procedures; trust in the senior management; and trust in the organization’s rewards.

22. The method of claim 14, wherein said expected and actual member responses comprises one or more of performance, behavior, and decision-making processes.

23. The method of claim 14, wherein said results comprise one or more in a group comprising swim charts of the expected, predicted, and/or actual crisis-scenario member responses; heat maps; interaction maps; and any combination thereof.

24. The method of claim 14, wherein said observed member response data further comprises initiative, diversity, perception, responsiveness, comeback, perceived centrality, burn-out, and any combination thereof.

25. The method of claim 14, further comprising a step of scoring one or more member for one or more of degree of centrality to communication, perception of centrality, influence, situational awareness, compliance with pre-determined guidelines, and adaptability; said scores calculated as a function of said observed member response and/or said obtained member data.

26. The method of claim 14, further comprising a step of messaging between said members during said simulation, wherein said actual data of a said member further comprises data of said messaging of said member.

27. The method of claim 14, wherein said second function (for forecasting success) comprises a count of said discrepancies.

28. (canceled)

29. An apparatus 700 for evaluating a crisis management plan, said apparatus comprising.
a. a computer system 705 comprising at least one processor 710 and at least one CRM 715; and
b. one or more terminals 720;
c. one or more display devices 725; said instructions stored on said CRM 715 are configured for processor to perform the method of claim 1 100 for evaluating a crisis management plan, said method 100 comprising steps of a. obtaining planned responses of members of an organization to a crisis, said planned
responses comprising planned operating procedures of the organization in the event of a crisis 105; and constructing a planned-response process flow 107;
b. obtaining data from questionnaires administered to members of the organization
on said members social interactions, past experience and predicting member responses flow
d. simulating a crisis scenario and (i) obtaining data on responses of members during the simulated crisis and constructing observed member responses process flow
e. recording gaps or differences between
i. planned responses of the members of the organization and the predicted responses of the members of the organization
ii. planned responses and observed responses iii. predicted responses and observed responses.
